(19) United States
(12) Patent Application Publication
(10) Pub. No.: US 2010/0138221 A1
(43) Pub. Date: Jun. 3, 2010

(54) DEDICATED HARDWARE/SOFTWARE VOICE-TO-TEXT SYSTEM

(76) Inventor: Donald R. Boys, Aromas, CA (US)

Correspondence Address: CENTRAL COAST PATENT AGENCY, INC, 3 HANGAR WAY SUITE D, WATSONVILLE, CA, 95076, US

(21) Appl. No.: 12/326,299

(22) Filed: Dec. 2, 2008

(51) Int. Cl. G10L 15/26

(52) U.S. Cl. 704/235; 704/E15.043

(57) ABSTRACT

A text preparation system has a first and a second CPU, with the first dedicated to a conventional voice-to-text software and the second to all other functions including a voice-to-text correction software. Voice commands enable the user to initiate the first and the second voice-to-text software and associated lexicons alternately, the second software and lexicon providing a corrections mode for errors made by the first voice-to-text software.

### CROSS-REFERENCE TO RELATED APPLICATIONS

N/A

### BACKGROUND OF THE INVENTION

1. Field of the Invention

This invention is in the field of input aids for producing a machine readable text, and pertains more particularly to a dedicated system for producing text from voice input.

2. Description of Related Art

Voice to text systems are very well known in the art, and there are many commercial systems available, all of which to the inventor's knowledge are software systems made to be executed on general-purpose computers. A serious problem with these systems is that general-purpose computers are almost always engaged in a number of tasks other than executing voice to text software. For example, a laptop or desktop computer in use by a person interested in using voice text may typically be executing several programs, such as e-mail applications, drawing programs, word processing programs, Internet browsers and the like. One problem is that voice to text requires near real time execution. And execution suffers if the central processing unit (CPU) use busy at any point in time processing data for another program or application. A similar problem has to do with memory availability and usage. A good voice to text system requires a considerable amount of random access memory. Also, the recognition and lookup operations for voice to text are non-trivial. As a result a voice to text system might work quite well at some times and not well at all at other times.

The present inventor believes all of the problems described above may be solved, and a voice to text system may be provided that works well at all times, if the software or firmware for the system are executed on a dedicated platform that is not shared with any other program execution. The art also needs a simplified system that does not require a keyboard and a wide range of functions that are seldom used.

### BRIEF SUMMARY OF THE INVENTION

The inventor has tried several times to use and rely on voice-to-text for preparing documents, but has found the systems available to be slow and prone to errors, but has also noticed that there seems to be a relationship between CPU power and availability, and the effective operation of a voice-to-text system. Also, it seems a main purpose of voice-to-text is to minimize or eliminate use of a keyboard. The inventor therefore has provided a system that does not use a keyboard, and has CPU exclusivity and power to speed up the operation and minimize errors.

Accordingly the inventor provides a text preparation system having a first and a second CPU, a random access memory (RAM), an audio coder-decoder (CODEC) module, a Universal Serial Bus (USB) module, a persistent memory and a display module interconnected by a bus system. The system also has one or more USB interfaces, a video output interface, a microphone input, a power input connection, and a pointer input device, all implemented on outside surfaces of a physical framework, and all communicating with elements connected to the bus system, and a video display coupled to the display module connected to the bus system. There is in addition a first voice-to-text software executed exclusively by the first CPU, which is dedicated to only the first voice-to-text software, selecting from a first lexicon comprising words and phrases in response to voice input by a user and entering the words and phrases in a document as machine-readable text, and a second voice-to-text software executed by the second CPU and operating as a correction application, selecting characters comprising letters and punctuation marks from a second lexicon. Voice commands enable the user to initiate the first and the second voice-to-text software and associated lexicons alternately, the second software and lexicon providing a corrections mode for errors made by the first voice-to-text software.

The inventor also provides a method for enhancing voice-to-text operation in a computer, which has steps of executing a first voice-to-text software exclusively by a first CPU, selecting from a first lexicon comprising words and phrases in response to voice input by a user and entering the words and phrases in a document as machine-readable text, executing a second voice-to-text software by a second CPU as a correction application, selecting characters comprising letters and punctuation marks in response to voice input by the user from a second lexicon and entering the letters and or punctuation marks as machine-readable text, and providing commands for the user to switch from the first voice-to-text software to the corrections mode.

### BRIEF DESCRIPTION OF THE DRAWING FIGURES

FIG. 1 is a perspective view of a dedicated voice to text system in an embodiment of the present invention.

FIG. 2 is a block diagram showing internal elements of the system of FIG. 1.

FIG. 3 is an illustration of a display of a page of a document in use with the system of claims 1 and 2.

### DETAILED DESCRIPTION OF THE INVENTION

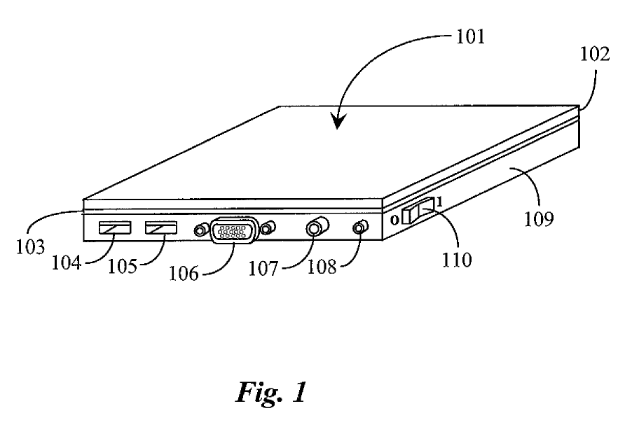

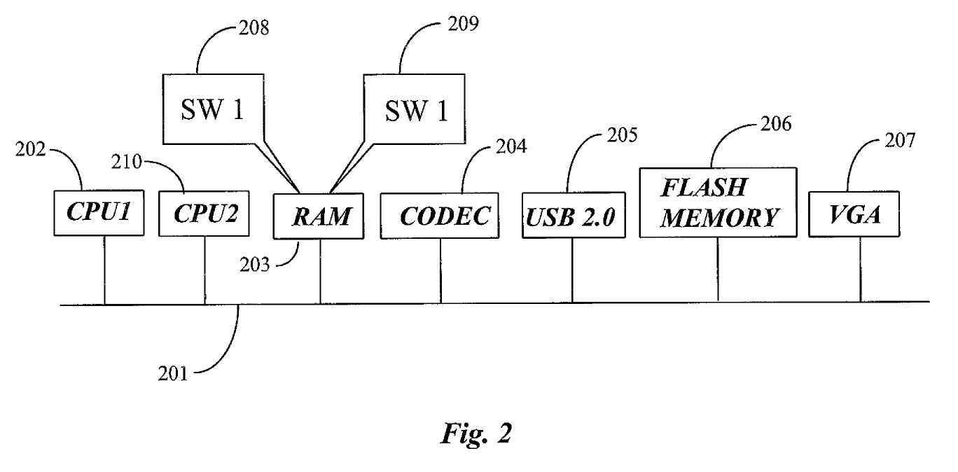

FIG. 1 is a perspective view of a dedicated voice to text system in an embodiment of the present invention. In this embodiment the system is implemented in a relatively small and flat aspect with a variety of I/O interfaces along one or more edges of the body of the system. FIG. 2 is a block diagram of some internal elements and connectivity of the dedicated voice-to-text system. Referring to FIG. 1, system 101 in this embodiment comprises a metal heat sink plate 109 which also provides structural integrity for the system, a PCB layer 103 upon which digital and other semiconductor elements are mounted and interconnected, and a cover layer 102, which may be any of several suitable materials, such as polymer materials, for protection of the PCB elements.

A variety of I/O connector/interfaces are implemented in this embodiment along edges of heat sink 109, comprising two USB 2.0 ports 104 and 105, a VGA cable connector 106, a microphone input 107, and low-voltage power input 108 for connecting a transformer (not shown) to provide power to the system, and an on/off switch 110. One additional element is a touchpad 111 to act as a pointer device in operation. In another embodiment there is no built-in touchpad, but a pointer, such as a mouse device or touchpad may be connected through either one of the USB ports 103 or 104.

Referring now to FIG. 2, a bus system 201 provides communication for internal components. The bus may be any one of several sorts, but a fast, parallel bus is preferable, as is used in general purpose computers, such as personal computers (PCs). Channels in an upper surface of heat sink 109 provide paths for connection between I/O ports shown in FIG. 1 and functional electronic elements shown in FIG. 2. These channels are not shown in the drawings, but are not important to the heart of the invention, and may be implemented in a number of conventional ways. There are two CPUs 202 and 210 in this embodiment communicating on bus 201, one labeled CPU1 and the other CPU2. An audiocoder-decoder module (CODEC) 204 provides digital processing for audio data, such as input through microphone port 108. A USB 2.0 module 205 provides support for USB communication through USB ports 103 and 104, and a VGA module 207 provides support for video output via VGA port 106 to external displays in this embodiment

Dedicated CPU1 202 provides code execution for software module SW1 that executes from random access memory 203. This software is stored in persistent memory 206, which is in this case flash memory, but could be any of a variety of non-volatile memory types, and is loaded to RAM 203 during initiation (boot) of the system, as is known in the art. CPU2 210 provides code execution for all code devoted to support of video display functions, USB operations, codec operations and the like; that is, all code other than SW 202, which is executed by CPU1 202. CPU2 210 also executes SW 208, functionality of which is described in detail further below.

Software 208 in the embodiment illustrated is a more or less conventional voice-to-text software system, several of which are available from different commercial companies, such as Nuance Communications, Inc. In some embodiments SW 208 may be a proprietary version of a voice-to-text software suite, and the functionality in every case is the usual functionality of recognizing human speech, and providing from a substantial lexicon words in machine-readable text to match voice input, the words provided in an electronic document, which may be a word processor document as known in the art.

System 101 shown differs essentially from a general-purpose computer executing a voice-to-text system in several ways. One difference is that CPU1 202 is devoted entirely to SW1 208, which is CPU-intensive voice-to-text software, operating to provided strings of words in response to voice input. Another difference is that a keyboard is not provided. Even though there are USB ports and functionality, there is no functionality in a preferred embodiment to accommodate keyboard input. An important object of the invention is to remove the necessity and use of a keyboard.

In the embodiment shown, all operational, that is CPU functionality, other than the operations of voice-to-text software 208 is provided by CPU2 210. This includes memory management, USB operations, codec operations, and display operations, and execution of SW2 209. This provision of dedicated CPUs and separation of functions allows one powerful CPU to be dedicated at all times to the operation of the CPU-intensive voice-to-text SW1 dealing almost exclusively with words in a large lexicon. The point is to maximize primarily the speed of operation of flowing the resulting text into a document or other file, as well as displaying the word strings for a user, but also to maximize accuracy.

Even though the dedicated CPU approach maximizes accuracy and minimizes latency in word flow, and even though this unique approach allows very large lexicon to be employed, there are always words known to a user that may not be in the available machine-readable lexicon. In that case SW1 208 will make the best available match, which will be a wrong match, and correction by the user will be necessary without a keyboard. This is the purpose of SW2 209.

SW2 209 is a correction program made to operate along with touchpad 111 (or in some embodiments a pointer device connected through one of the USB ports, or another input. SW1 208 operates with a word (and in some instances phrase) lexicon which in all cases is a substantial lexicon. There are tens of thousands of words in the English language, and in most other languages as well, and the task of the voice-to-text software is to separate the user's speech into words and phrases, and to match the audio data with words or phrases in the substantial lexicon. Again, as stated several times before, this is a challenging task for any computer system.

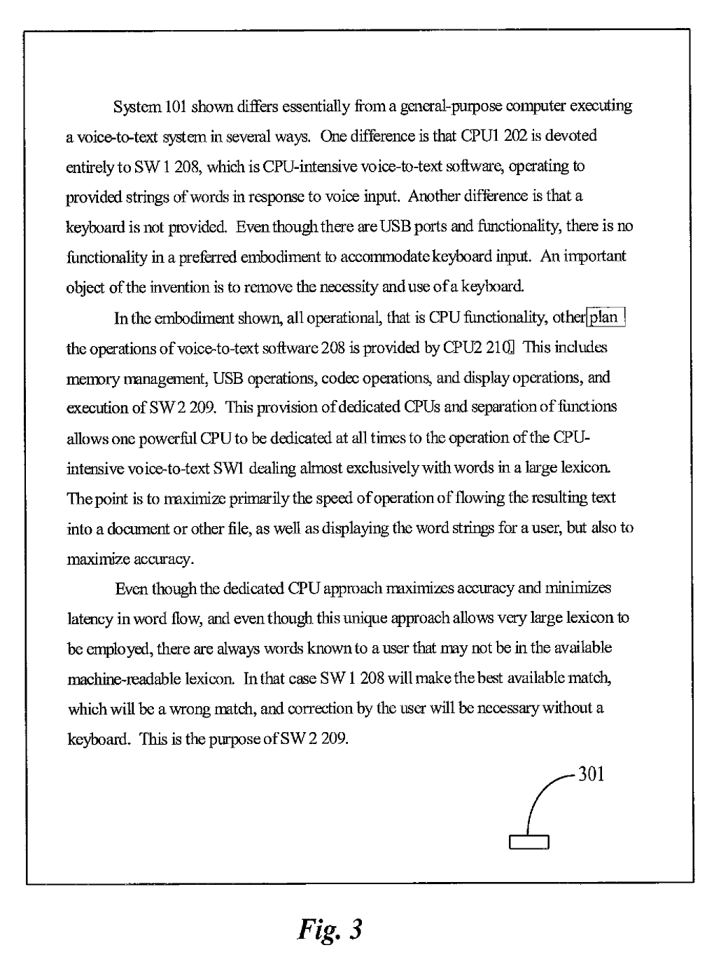

In embodiments of the present invention, particularly because a keyboard is not available, there needs to be a reliable means for correcting any mistakes that the principle voice-to-text SW1 208 might make. Correction is the purpose and task of SW2 209. FIG. 3 illustrates an example of text entered in a page of a word processor document by the system of the invention in response to a user speaking into a microphone connected to the system. The display is in any monitor connected to the system via, for example VGA connector 106. Displays may also be connected via one of the USB ports, and in some embodiments S-Video outputs are provided to connect to a TV monitor.

A cursor 301 is illustrated in a lower portion of the page shown, having a rectangular shape. The shape of this cursor is not important, it is just necessary that the cursor be visible in the page as the user moves it, so the user is guided in placing the cursor. The cursor moves in the display in response to input by a user with a pointer, in a preferred embodiment touchpad 111, but in some embodiments a separate pointer device connected at one of the two USB ports.

The cursor and select operation in an embodiment of this invention operates a bit differently than systems known in the art. As a user moves the cursor, and the cursor is located over a word in the page, that word is automatically selected. This is known in the art as a “mouseover”. It is, however, not necessary to use the cursor unless it is needed to make a correction in the text or punctuation. So, when the system is in the principle voice-to-text mode executed via software 208, the user will see text flowing onto the page, as well as punctuation, and voice commands for indention and the like are also available, as is known in the art for voice-to-text operation. The voice input mode is a default mode.

When a user notices an error made by the system, the user uses a voice command to switch to correction mode operated through software 209. Any of several commands will suffice, for example the word “fix”. In another embodiment the signal to go to corrections mode may be a tap or other pre-programmed action on the touchpad, a click on a mouse, or a touch of a special button provided on the body of the subsystem, perhaps proximate the touchpad.

With the correction command recognized, the system switches to the correction mode, and the cursor appears. In the correction mode operation of SW1 208 is temporarily suspended, and operation is switched to SW2 209, executed by CPU2 210. An important object of the correction mode is to provide for correcting errors made by the main voice-to-text mode. The corrections mode in this embodiment is another voice to text software, but with a very specific lexicon and operation. The principle, default mode uses a very extensive lexicon of words and phrases, but the corrections mode operates with characters and punctuation marks only. Assuming English as a language used with the system, the lexicon for corrections mode comprises all of the twenty-four letters in the English alphabet, all of the punctuation marks, such as a period, a comma, a question mark, quotation marks, and so on, and at least one command, used to end the corrections mode and return to the default mode.

It should be noted that the lexicon for the corrections mode is very small, in preferred embodiments fewer than 100 selections, and therefore operation will be very fast, and since every user will use exactly the contents of the lexicon, operation will be error free. In some embodiments the user will be informed to use some special input to distinguish between “m” and “n” for example, which may be difficult to distinguish in voice-to-character correction mode.

Referring now to FIG. 3 again, notice that in the first line of the second paragraph the word “plan” should have been “than”. Using the touchpad or other pointer device the user will move the cursor over the word “plan” which will cause the word to be selected. When selected, the word may be marked, such as by a rectangle surrounding the word, as shown in FIG. 3. There are a number of different ways the selection may be shown, such as by highlighting in a color. Once the word is selected, the user simply spells the correct word, in this case by speaking the letters “t”, “h”, “a” and “n”. The letters appear in the display in order as spoken, and a short delay after the last letter signals the corrections mode that the corrected word is compete. At this point the cursor automatically moves to the first space beyond the corrected word to the right, to accept, if the user desires, a punctuation mark. If a punctuation is needed, the user speaks it, and the system enters it. If not, the user may move the cursor to any other word, to select and correct that word, or to any single space in the displayed text, to add or correct a punctuation mark.

When the user is done with correction, he or she speaks a command to send the system back to the default mode to enter words or phrases. The command may be “Done” or “Resume” or any other command word that is appropriate.

During operation the system automatically saves the total entry on a very short periodic basis, such as every two seconds, so when the user is finished with entry for a particular project or document, that document is saved in a file in either RAM 203 or Flash 206. In one embodiment connecting a USB thumb drive to one of the USB ports causes the finished document to be loaded to the thumb drive, after which the thumb drive may be removed and the file transferred to, for example, a general-purpose computer, where it may be loaded to a different application. In one embodiment, when the file is transferred to a removable drive, the file in RAM 203 or Flash 206 is erased.

In some embodiments one or both of the default mode and the corrections mode have a command for “save as”, after which the user may speak a file name, after which the system will save the file with a name. In this embodiment a user may prepare and save several files, all of which may be transferred to a USB removable drive either automatically when the drive is engaged, or there may be voice commands to accomplish such transfer.

So in a preferred embodiment of the invention a text preparation system is provided, having a first and a second CPU, a random access memory (RAM), an audio coder-decoder (CODEC) module, a Universal Serial Bus (USB) module, a persistent memory and a display module interconnected by a bus system. There are also one or more USB interfaces, a video output interface, a microphone input, a power input connection, and a pointer input device, all implemented on outside surfaces of a physical framework, and all communicating with elements connected to the bus system, and a video display coupled to the display module connected to the bus system. In addition there is a first voice-to-text software executed exclusively by the first CPU, which is dedicated to only the first voice-to-text software, selecting from a first lexicon comprising words and phrases in response to voice input by a user and entering the words and phrases in a document as machine-readable text, and a second voice-to-text software executed by the second CPU and operating as a correction application, selecting characters comprising letters and punctuation marks from a second lexicon. Voice commands enable the user to initiate the first and the second voice-to-text software and associated lexicons alternately, the second software and lexicon providing a corrections mode for errors made by the first voice-to-text software.

Also in a preferred embodiment a method for enhancing voice-to-text operation in a computer is provided, comprising steps of executing a first voice-to-text software exclusively by a first CPU, selecting from a first lexicon comprising words and phrases in response to voice input by a user and entering the words and phrases in a document as machine-readable text, executing a second voice-to-text software by a second CPU as a correction application, selecting characters comprising letters and punctuation marks in response to voice input by the user from a second lexicon and entering the letters and or punctuation marks as machine-readable text, and providing commands for the user to switch from the first voice-to-text software to the corrections mode.

Several embodiments of the invention, as examples, have been described above, including a system and a method described as preferred embodiments just above, and many other embodiments are also possible following the unique features of the invention described by example. The scope of the invention is therefore only limited by the claims that follow.

1. A text preparation system, comprising:
a first and a second CPU, a random access memory (RAM), an audio coder-decoder (CODEC) module, a Universal Serial Bus (USB) module, a persistent memory and a display module interconnected by a bus system;
one or more USB interfaces, a video output interface, a microphone input, a power input connection, and a pointer input device, all implemented on outside surfaces of a physical framework, and all communicating with elements connected to the bus system;
a video display coupled to the display module connected to the bus system;
a first voice-to-text software executed exclusively by the first CPU, which is dedicated to only the first voice-to-text software, selecting from a first lexicon comprising words and phrases in response to voice input by a user and entering the words and phrases in a document as machine-readable text; and
a second voice-to-text software executed by the second CPU and operating as a correction application, selecting characters comprising letters and punctuation marks from a second lexicon;
wherein voice commands enable the user to initiate the first and the second voice-to-text software and associated lexicons alternately, the second software and lexicon providing a corrections mode for errors made by the first voice-to-text software.

2. The system of claim 1 wherein the pointer device is a touchpad implemented on an upper surface of the framework.

3. The system of claim 1 wherein the pointer device is connected through one of the one or more USB interfaces.

4. The system of claim 1 wherein the video display is connected through the video output interface.

5. The system of claim 1 wherein a cursor appears in the display, moveable by the pointer device, when a user causes the system to enter the correction mode.

6. The system of claim 5 wherein, when the cursor intersects the space of a word in the display, that word is selected.

7. The system of claim 6 wherein, when the user enunciates a series of letters with a word selected, the letters replace the word selected in the text displayed.

8. The system of claim 7 wherein, when the user pauses for at least a programmed period of time after enunciating the series of letters, the letters are accepted as a word replacing the word selected, and a space following the word is selected for input, enabling the user to enunciate a punctuation mark for the space.

9. A method for enhancing voice-to-text operation in a computer, comprising the steps of:
(a) executing a first voice-to-text software exclusively by a first CPU, selecting from a first lexicon comprising words and phrases in response to voice input by a user and entering the words and phrases in a document as machine-readable text;
(b) executing a second voice-to-text software by a second CPU as a correction application, selecting characters comprising letters and punctuation marks in response to voice input by the user from a second lexicon and entering the letters and or punctuation marks as machine-readable text; and
(c) providing commands for the user to switch from the first voice-to-text software to the corrections mode.

10. The method of claim 9 further comprising a step for using a pointer device to move a cursor to select a word for correction when in the corrections mode.

11. The method of claim 10 wherein, when the cursor intersects the space of a word in the display, that word is selected for correction.

12. The method of claim 11 wherein, when the user enunciates a series of letters with a word selected, the letters replace the word selected in the text displayed.

13. The method of claim 12 wherein, when the user pauses for at least a programmed period of time after enunciating the series of letters, the letters are accepted as a word replacing the word selected, and a space following the word is selected for input, enabling the user to enunciate a punctuation mark for the space.
